(19) United States
(12) Patent Application Publication
(10) Pub. No.: US 2009/0289829 A1
(43) Pub. Date: Nov. 26, 2009

(54) PROGRAMMABLE REMOTE CONTROL AND METHOD FOR PROGRAMMING A REMOTE CONTROL

(75) Inventor: Ferdinand Maier, Obertrum am See (AT)

Correspondence Address: SENNIGER POWERS LLP, 100 NORTH BROADWAY, 17TH FLOOR, ST LOUIS, MO, 63102, US

(73) Assignee: FM MARKETING GMBH, Obertrum am See (AT)

(21) Appl. No.: 12/465,393

(22) Filed: May 13, 2009

(30) Foreign Application Priority Data
May 21, 2008 (DE) 102008024632.8

(51) Int. Cl. G08C 19/12; G06F 17/30

(52) U.S. Cl. 341/176; 707/3; 707/E17.014; 707/E17.044

(57) ABSTRACT

A programmable remote control and programming method for a remote control employing an original remote control and an internal or external database in which a plurality of code combinations is stored. When a first code assigned to a predetermined button is received, it is selected in the database which code combinations contain this code assigned to the predetermined function. If several code combinations are selected, then prompts are displayed for a second code and possibly additional codes for other buttons or combinations of buttons and, in the database, the code combinations in which there are corresponding matches between codes and button functions are selected. This process is repeated until only a single code combination is selected. All of the codes for the selected code combination are then imported and assigned to the individual buttons or combinations of buttons.

### REFERENCE TO RELATED APPLICATIONS

This application claims priority to German application DE 102008024632.8 filed 21 May 2008, the entire disclosure of which is expressly incorporated by reference.

### FIELD OF THE INVENTION

The invention relates to a programmable remote control of the type which has a receiver, a microprocessor, and a memory in which codes can be stored that are assigned to individual buttons or combinations of buttons on the keypad. The invention also relates to a method for programming a remote control.

### BACKGROUND

Remote control and methods of this type are known from U.S. Pat. No. 4,626,848A. In this document, a programmable universal remote control is proposed that receives, decodes, and stores remote control codes that are transmitted by an original remote control, so that the remote control to be programmed “learns” the appropriate codes of the original remote control. The programmable remote control then duplicates the original remote control with respect to its function.

Modern remote controls for electronic devices, such as television receivers, satellite receivers, videorecorders, CD playback devices, music systems, etc., have a large number of buttons and combinations of buttons, each of which is assigned a certain code that is transmitted typically as a coded infrared signal. Remote controls with more than 40 buttons are very common.

The device to be controlled remotely receives the code and executes functions assigned to this code.

Normally, a separate remote control is supplied with each device. Each remote control stores the code combinations matching the associated device. Therefore, in practice, various remote controls for controlling various devices are found in a single household, which for many users is too much of a burden and impractical.

Therefore, it is desirable to control a plurality of different devices with a single remote control. For this purpose, the known programmable remote controls, such as those described in U.S. Pat. No. 4,626,848 named above, require the codes to be learned to be entered for each individual button or combinations of buttons, which is labor- and time-intensive.

For years, universal remote controls that hold a plurality of code combinations stored in a memory have also been available on the market. The user can then look for an identification number for his device in a printed table, wherein this identification number designates the corresponding code combination. By entering this identification number, the corresponding code combination is activated and corresponding codes are assigned to the individual buttons. With the plurality of devices available on the market, it is hardly possible to provide all of the code combinations, especially because the same manufacturer often uses a plurality of different code combinations. In this case, the only possibility remaining for the user is to try out a plurality of code combinations and to hope that the code combination expected by his or her device is present in the universal remote control. This “try-out method” is also extremely time-consuming.

It is also already known to perform a code search automatically. Here, the universal remote control emits different codes one after the other for the on/off function of the devices. If the device turns on or off, then the other functions of the other buttons must be tested, since in many devices the same code is indeed used for the on/off function, but the codes for the other buttons are different. Therefore, this method is also time- and labor-intensive.

### SUMMARY

Therefore, the problem of the invention is to improve the known programmable remote control to the extent that its programming is significantly simplified. This problem is solved by the features specified in Claims 1, 6, 7, and 8. Advantageous implementations and refinements of the invention follow from the subordinate claims.

The basic concept of the invention is that, in a first step, the remote control to be programmed learns the code of only one designated button (e.g., the on/off button) and then, in a second step, it is checked in a database which code combinations have been assigned to this learned code of the corresponding button. These “matching” code combinations are then selected for further programming. In an optional additional step, the user is prompted to input another code of another button, whereupon it is again checked in a database which combinations have the two entered codes for the two-button functions. It is especially advantageous if the prompts in this second step and possibly additional steps are for functions in which the previously selected code combinations differ from each other. Thus, matching functions of the selected code combinations are skipped and there are no prompts for these functions. This process is repeated until a unique, “correct” code combination has been determined. Despite the enormous plurality of code combinations on the market, in practice, the correct code combination is found after two to three learning steps.

The database with all of the common code combinations can be stored on a memory chip in the universal remote control. It is also possible to keep the database on a PC and to supply all of the codes to the customer on a CD-ROM. Finally, it is also possible to query the database via the Internet.

### BRIEF DESCRIPTION OF THE FIGURES

Below, the invention will be explained in greater detail with reference to embodiments in connection with the drawing. Shown are:

FIG. 1: a schematic diagram of a programmable remote control with integrated database,

FIG. 2: a schematic diagram of a programmable remote control with external database,

FIG. 3: a table of code combinations for explaining the invention, and

FIG. 4: a flow chart for explaining the processing steps of the invention.

### DETAILED DESCRIPTION OF PREFERRED EMBODIMENTS

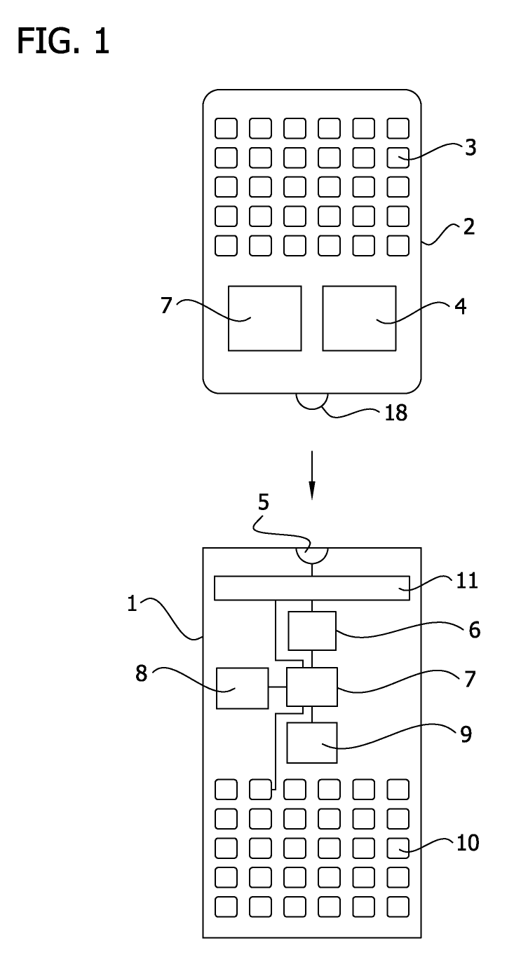

FIG. 1 shows schematically a universal remote control 1 that is to be programmed and that is to learn the corresponding codes from an existing original remote control 2. The original remote control 2 has a plurality of buttons 3 that are each assigned a designated code that is emitted as a coded infrared signal by means of a light-emitting diode 18 The set of all codes assigned to the buttons for an individual original remote control 2 is designated as the code combination that is stored in a memory 4 of the original remote control. The operation of the original remote control 2 is controlled by means of a microprocessor 7′.

The universal remote control 1 to be programmed contains a receiving diode 5 of a known structure, a receiving and decoding unit 6, a microprocessor 7, and a memory 8, as well as a keypad 10. In this respect, it involves a conventional programmable remote control. The receiving diode 5 can also be, incidentally, the transmitting diode for the subsequent use of the universal remote control 1, wherein the microprocessor 7 controls the switching between the transmit and receive modes.

According to the invention, in the embodiment of FIG. 1, a database 9 is present in the programmable remote control 1, wherein a plurality of code combinations is stored in this database with which all of the remote-controlled devices on the market are covered as much as possible. Finally, the programmable remote control 1 can also contain a display 11 by means of which instructions or information can be shown to the user. Instead of a display, however, for more economical variants, a light-emitting diode (LED) could also be used that outputs appropriate signals by blinking. It is also possible to output acoustic signals.

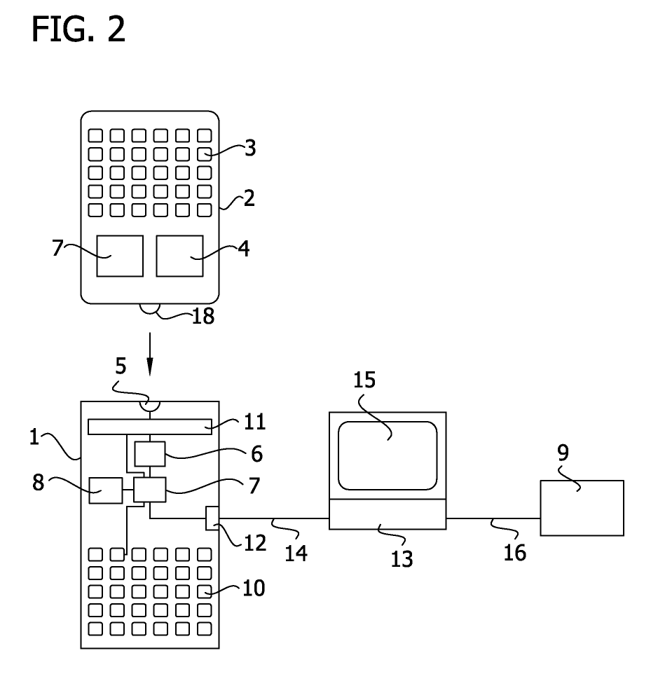

The embodiment of FIG. 2 differs from that of FIG. 1 essentially in that the database 9 is arranged externally, that is, outside of the remote control 1 to be programmed, and that the remote control 1 has an interface 12 by means of which the remote control 1 can be connected to a computer 13.

This can be, for example, a USB interface by means of which the remote control 1 is connected to the computer 13 with a cable 14. The database 9 can then be stored in the computer 13 or can be queried by the computer 13 via a CD-ROM. A part of the receiving and decoding unit 6 could also be moved into the computer 13, namely, for example, the decoding function and/or an analysis function. In this case, the receiving unit 6 then still has the task of only converting the received infrared signal into a digitized bit stream that is sent under the control of the microprocessor 7 via the interface 12 to the computer 13, where it is analyzed and decoded. This function could also be shifted via the Internet to an external area, for example, the manufacturer.

In principle, the analysis consists in identifying the given infrared system from characteristics of the bit stream, such as carrier frequency and times between different frames. The actual “code” is then extracted from this system as a digitized beamer signal.

The database 9 can also be stored externally at a manufacturer and queried by the computer 13 via an Internet connection 16.

The programming of the remote control 1 takes place as follows: the remote control 1 is set to the “programming” operating mode by a switch or by pressing a certain combination of buttons. The user is then prompted, e.g., by means of the display 11, to press a predetermined button on the original remote control 2 and therefore to trigger a predetermined function. This can be, for example, the on/off function. The original remote control 2 then sends, via the transmitting diode 18, a correspondingly coded infrared signal that is received by the receiving diode 5 of the remote control 1 and that is fed to the microprocessor 7 after decoding in the receiver/decoder 6 as a digital signal. The microprocessor 7 checks whether one or more code combinations in which the previously received code is assigned to the corresponding function are stored in the database 9. Usually, for this first code there are still several code combinations in the database 9 for which this condition is true. If this is the case, then under the control of the microprocessor 7, the user is prompted by means of the display 11 to press another predetermined button on the original remote control 2, for example, the button for “change channel up” for a television set. If this is performed by the user, the second code is transmitted and processed in the same way and, under the control of the microprocessor 7, it is checked in the database 9 whether one or more code combinations are present in which the previously received two codes are assigned to the two predetermined functions. In this step, if several matching code combinations are still found, prompts are also displayed in the same way for a third code, fourth code, etc., until only one unique code combination in the database 9 is selected. If this is the case, all of the codes of this selected code combination are imported; for example, these codes are then read into the memory 8. However, it is also possible to store only the memory address of the selected code combination of the database 9 in the memory 8 and for subsequent operation, the corresponding codes are queried from the database 9.

If a unique code combination has been selected in the way described above, the programming process is ended and the universal remote control 1 can be set to the normal operating mode either automatically or by pressing a predetermined combination of buttons.

It has been shown that, in practice, despite a very large number of a few thousand typical code combinations, the correct code combination can be found in two to three steps. In this way, the programming is considerably simplified and can be performed, in practice, within a few seconds.

The sequence of the programming in the embodiment of FIG. 2 takes place in an analogous way, in that the external database 9 is queried via the interface 12 and the computer 13. If the matching code combination in the database 9 is determined in this way, this code combination is written to the memory 8 and the interface 12 can be disconnected. The sequence control can also be performed in the embodiment of FIG. 2 by the computer 13, in that a corresponding program is stored, wherein instructions for the steps to be performed could also be displayed by means of a screen 15 of the computer 13.

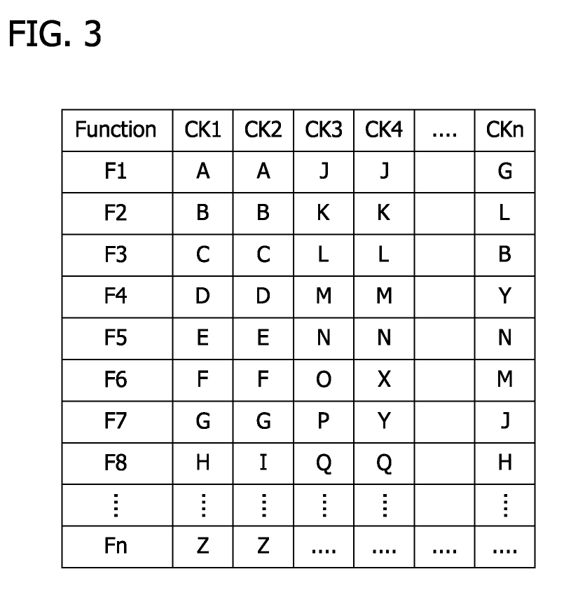

FIG. 3 shows schematically the organization of the database 9. Designated codes that are here specified with the letters A to Z are assigned to each function F1 to Fn that can be called by a button of the remote control 1. Here, the codes obviously involve digital codes with bit sequences that represent logical 1's or logical 0's. The database stores a large number of different code combinations CK1, CK2, to CKn. For example, the function F1 is assigned to the code A for the code combinations CK1 and CK2, to the code J for the code combinations CK3 and CK4, and to the code G for the code combination CKn. The function F2 is assigned to the code B for the code combinations CK1 and CK2, to the code K for the code combinations CK3 and CK4, and to the code G for the code combination CKn, etc. Furthermore, let it be assumed that the code combinations CK1 and CK2 are identical with respect to the codes for the functions F1 to F7 and differ only for the function F8.

Now let it be assumed that, in the first programming step, the function F1 is called and the original remote control 2 transmits the code A. In this way, the code combinations CK1 and CK2 are selected, while all of the other code combinations can be ruled out. The codes CK1 and CK2 are identical for the codes F1 to F7 and differ only for the function F8 and possibly for other functions. Therefore, in an especially advantageous way, in the next step, the function is called in which the codes of code combinations CK1 and CK2 no longer match—the function F8 in the embodiment of FIG. 3. Therefore, prompts need not be displayed for the matching functions F2 to F7. If the user presses the button assigned to the function F8, then, for example, the code H is transmitted, so that the code combination CK1 is uniquely identified, obviously under the prerequisite that all of the other functions F9 to Fn are, in turn, identical.

The programming with respect to the code combinations CK3 and CK4 takes place analogously. If the code J is identified for the first function F1, then, in the second step, the first non-matching function is called—the function F6 in the embodiment of FIG. 3.

In the second step, if several “matching” code combinations are still selected, prompts are displayed for a third function and possibly for additional functions until a unique code combination has been identified.

One can see that the “correct” code combination is selected in this way with few steps.

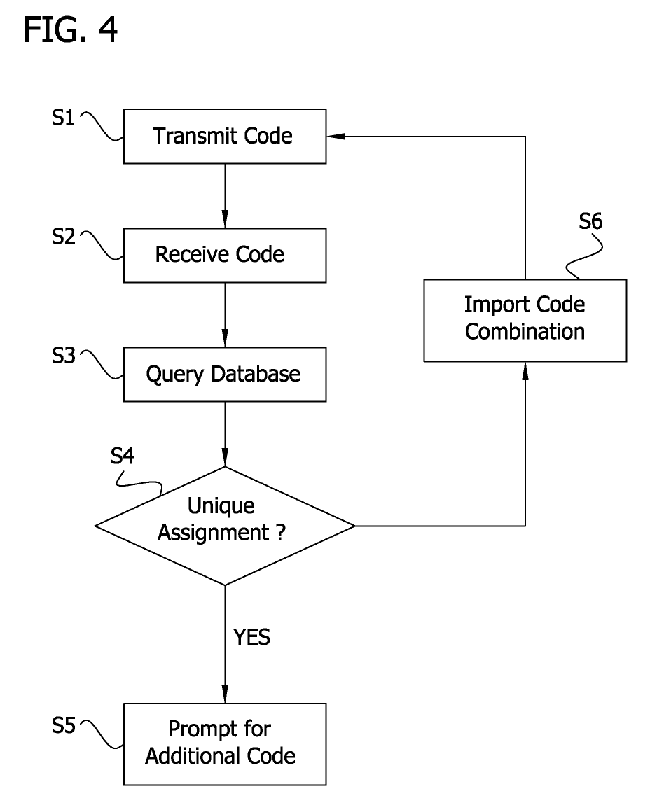

FIG. 4 again shows the processing steps in the form of a flow chart. In a first step S1, the first code is transmitted from the original remote control 2; in step S2, it is received and decoded by the remote control 1 to be programmed. In step S3, the database is queried and those code combinations that have the received code assigned to the corresponding function are selected. In step S4, it is checked whether only a single code combination in which the received code is assigned to the corresponding function is contained in the database. If this is the case, then, in step S5, the selected code combination is imported and stored in the remote control 1 to be programmed. If the test in step S4 has the result that several code combinations have been selected, then, in step S6, the user is prompted to press another predetermined button and the process goes to step S1. The additional predetermined button is determined, under the selected code combinations, according to the criteria that the codes of the corresponding function (or button) differ from each other. The loop formed in this way is traversed until the test in step S4 selects only one single code combination.

In the previously described programmable remote control and the described method, it is assumed that an original remote control is present with which the programmable remote control is programmed. The programmable remote control learns, so to speak, the matching code combination from the original remote control.

It is possible that the original remote control is not available and a programmable remote control must be reprogrammed. In this worst-case scenario, up until now one would have to look in a table for a number that identifies the code combination for the corresponding device. Here, however, it often happens that newer devices of different manufacturers are not yet listed in the corresponding table, so that all that remains is to try out the entire stock of code combinations, which, in the worst-case scenario, can take up to a few hours. Usually, the process begins with the on/off function, i.e., a television set is turned on and then all of the code combinations are retrieved onto the remote control one after the other and the on/off button is pressed until the television set responds accordingly. In this way, however, not all of the other key assignments are programmed correctly. With the invention, this case could also be significantly simplified. Namely, when “trying out” the different code combinations, as soon as the assignment of one button, such as the on/off button, is identified, the stock of stored code combinations is significantly restricted, and for the further “trying out” of code combinations, only a restricted number of code combinations is still provided. In this case, if, for example, the code combinations CK1 and CK2 are identified in the embodiment of FIG. 3, then the user is prompted to press the button for the function F8 and to check the response on the television set. Here, for example, the code combination CK1 is first selected, and if the code I is received when the function F8 is called, then no function or an incorrect function is triggered on the television set. The remote control switches to the next matching code combination—here the code combination CK2—and the user again presses the button for the function F8, whereupon the matching code I is then transmitted. From the corresponding reaction of the television set, the user recognizes that the matching code has been received, and thus the code combination CK2 has been uniquely identified.

This variant can also be executed analogously to FIG. 1 with an internal database 9 or analogously to FIG. 2 with an external database. In both variants, instead of the original remote control 2, an infrared signal is transmitted from the transmitting diode 18 to an associated device, such as a television set, and its response to a corresponding signal is awaited and, if it is the correct function, confirmed with a button, whereupon the stock of code combinations to be queried is then restricted for additional steps.

When introducing elements of the present invention or the preferred embodiment(s) thereof, the articles “a”, “an”, “the” and “said” are intended to mean that there are one or more of the elements. For example, that the foregoing description and following claims refer to “an” object means that there are one or more such objects. The terms “comprising”, “including” and “having” are intended to be inclusive and mean that there may be additional elements other than the listed elements.

As various changes could be made in the above without departing from the scope of the invention, it is intended that all matter contained in the above description and shown in the accompanying drawings shall be interpreted as illustrative and not in a limiting sense. The scope of invention is defined by the appended claims and modifications to the embodiments above may be made that do not depart from the scope of the invention.

1. A programmable remote control comprising:
a receiving unit for receiving coded signals;
a keypad;
a microprocessor; and
a memory in which codes can be stored that are assigned to individual buttons or combinations of buttons of the keypad; and
a database in which a plurality of code combinations is stored;
wherein, when a coded signal that is assigned to a predetermined button or combination of buttons of the keypad is received, the remote control selects in the database the code combination(s) in which the received coded signal is assigned to the predetermined button or combination of buttons, checks whether a single or several code combinations have been selected, and, as a function of this test, prompts for another coded signal for another button or combination of buttons until only a single code combination is still selected, wherein all of the codes of the selected code combination are then imported as valid codes for predetermined buttons or combinations of buttons.

2. The programmable remote control according to claim 1 wherein the database is integrated into the remote control.

3. The programmable remote control according to claim 1 wherein the database is external to the remote control and the remote control has an interface for connecting to the external database.

4. The programmable remote control according to claim 3 wherein the external database is stored in a computer.

5. The programmable remote control according to claim 3 wherein the external database is accessible via the Internet.

6. A method for programming a remote control with the following successive steps:
a) receiving a coded signal that is assigned to a predetermined function of the remote control,
b) decoding of the received signal for generating a digital code,
c) querying a database by selecting one or more code combinations in which the previously identified code is assigned to the predetermined function,
d) testing whether only one code combination or several code combinations in the database have been selected,
e) if several code combinations have been selected, prompting for another coded signal that is assigned to another button or combination of buttons and, after decoding, querying the database and selecting one or more code combinations in which the previously received codes are assigned to the predetermined buttons or combinations of buttons,
f) repeating the above steps a) to e) until only a single code combination is still selected, and
g) assigning all of the codes to predetermined buttons or combinations of buttons according to the selected code combination.

7. A programmable remote control comprising:
a transmit unit for transmitting coded signals;
a keypad;
a microprocessor;
a memory in which codes can be stored that are assigned to individual buttons or combinations of buttons of the keypad;
a database in which a plurality of code combinations is stored that can be called individually;
wherein, when a confirmation button is pressed, the remote control selects, in the database, the code combination or code combinations in which the last transmitted coded signal is assigned to the predetermined button or combination of buttons, checks whether a single or several code combinations have been selected, and, as a function of this test, transmits another coded signal for another button or combination of buttons until only a single code combination is still selected, wherein then all of the codes of the selected code combination are then imported as valid codes for predetermined buttons or combinations of buttons.

8. A method for programming a remote control with the following successive steps:
a) transmitting of a coded signal of a predetermined code combination that is assigned to a predetermined function of the remote control;
b) testing whether the transmitted signal triggers the assigned function on the device to be controlled remotely;
c) as a function of this testing, the possible prompting for additional code combinations until the transmitted coded signal triggers the assigned function on the device to be controlled remotely;
d) querying a database by selecting one or more code combinations in which the previously transmitted code is assigned to the predetermined function;
e) testing whether only one code combination or several code combinations in the database have been selected;
f) if several code combinations have been selected, transmission of another coded signal that is assigned to another button or combination of buttons, and optionally switching to the next selected code combination until the other transmitted signal has also triggered the predetermined function on the device to be controlled remotely;
g) repeating the above steps a) to f) until only a single code combination is still selected; and
h) assigning all of the codes to predetermined buttons or combinations of buttons according to the selected code combination.
